(19) United States
(12) Patent Application Publication
(10) Pub. No.: US 2010/0245016 A1
(43) Pub. Date: Sep. 30, 2010

(54) REACTOR FOR ELECTRICAL DEVICES

(75) Inventors: Mitsutoshi Kameda, Shinshiro-shi (JP); Kazuo Kato, Nagoya (JP); Takashi Aoki, Toyoake-shi (JP); Hiroyuki Okuhira, Kariya-shi (JP); Kouji Okamoto, Toyoake-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/732,464

(22) Filed: Mar. 26, 2010

(30) Foreign Application Priority Data
Mar. 27, 2009 (JP) 2009-078334

(51) Int. Cl. H01F 17/04

(52) U.S. Cl. 336/221

(57) ABSTRACT

A reactor includes a tubular coil and a core. The coil generates magnetic flux when a current is supplied thereto. The core is made of magnetic powder-containing resin, and is arranged to cover the coil. An entire surface of the coil is covered with an insulation coating. The insulation coating has corner portions that cover corner portions of the coil. The corner portions of the coil are formed between two opposing end surfaces (axial end surfaces) of the coil and an inner circumference surface of the coil, and between the two axial end surfaces of the coil and an outer circumference surface of the coil, when viewed in a cross section that is perpendicular to the direction the coil is wound. Each corner portion includes a curved surface portion formed with a circularly curved surface portion having a curvature radius of 0.2 mm or more. A minimum thickness of the corner portion is 0.2 mm or more. The elastic modulus of the core is 5 to 25 GPa.

### CROSS-REFERENCE TO RELATED APPLICATION

This application is based on and claims the benefit of priority from earlier Japanese Patent Application No 2009-78334 filed on Mar. 27, 2009, the description, of which is incorporated herein by reference.

### BACKGROUND OF THE INVENTION

1. Background of the Invention

The present invention relates to a reactor used for electrical devices such as electrical power conversion systems. For instance, reactors are used for DC/DC convertors of a variety of types of electric vehicles including hybrid electric vehicles, power conditioners used for solar energy generation (i.e., photovoltaics) and wind-generated electricity, and inverters used for energy-saving home electronics such as air conditioners.

2. Related Art

A reactor used for devices such as power converters has been known. The reactor generally includes a coil and a core. The coil is made of a conductive wire that is spirally wound. The coil generates magnetic flux when a current is supplied. The core is made of magnetic powder-containing resin that is a mixture of insulation resin and magnetic powder.

One type of reactor is disclosed in Japanese Unexamined Patent publication No. 2006-4957, This reactor includes a coil, to which high voltage is applied, whose entire surface is covered with an insulation coating that insulates and protects the coil.

The conventional reactor described above has the following disadvantages.

That is, the coil included in the reactor generates heat when the reactor is in operation, as a current is supplied thereto, while the coil does not generate heat when the reactor is not in operation. The reactor adapted to have the operation period and non-operation period alternately and repeatedly causes the coil to expand and shrink, which generates stress in the coil and its periphery (the generation of stress caused by a repetition of operation and non-operation periods of the coil). Further, even in a non-operation period, the coil expands and shrinks due to temperature variation, particularly when used under an environment with great temperature variation. In this stage, the degree of the expansion and shrinkage varies between different portions of the coil, which generates stress inside the coil (the generation of stress caused by thermal cycles of the coil).

The generated stress tends to concentrate on the corners of the coil. If the entire surface of the coil is covered with the insulation coating like the one disclosed in Japanese Unexamined Patent publication No. 2006-4957, the stress tends to concentrate around such portions of the insulation coating that cover corner portions of the coil. This can generate cracks in the core, and the cracks occur initially from the portions of the insulation coating covering the corner portions of the coil. The cracks generated in the core cut magnetic flux that is generated by a current supplied to the coil, which cause the reactor to form reduced magnetic flux and have inappropriate magnetic properties.

### SUMMARY OF THE INVENTION

It is therefore an object of the invention to provide a reactor that prevents generation of cracks, and has appropriate magnetic properties as well as improved durability and reliability.

A reactor according to an aspect of the invention includes a cylindrically formed coil, and a core. The coil is made of a conductive wire that is spirally wound. The coil generates magnetic flux when a current is supplied to the coil. The core is made of magnetic powder-containing resin that is a mixture of insulation resin and magnetic powder. The core surrounds the coil.

An entire surface of the coil is covered with an insulation coating. The insulation coating includes corner portions that cover corner portions of the coil. The corner portions of the coil are formed between two opposing axial end surfaces of the coil and an inner circumference surface of the coil, and between the two opposing axial end surfaces of the coil and an outer circumference surface of the coil, when viewed in a cross section that is perpendicular to the direction the coil is wound. Each corner portion of the insulation coating includes a curved surface portion formed with a circularly curved surface having the curvature radius of 0.2 mm or more. The minimum thickness of the corner portions of the insulation coating is 0.2 mm or more. The core abutting the insulation coating has the elastic modulus of 5 to 25 GPa at room temperature.

As mentioned above, the reactor according to the aspect of the invention includes the coil whose entire surface is covered with the insulation coating. The insulation coating includes the corner portions that cover the respective corner portions of the coil. Each of the corner portions of the insulation coating has the curved surface portion formed with the circularly curved surface.

The corner portions of the insulation coating having the curved surface portions are able to efficiently diffuse and ease the stress that is generated around the corner portions of the insulation coating caused by the repetition of operation and non-operation periods of the coil as well as by the thermal cycles of the coil. That is, the corner portions of the insulation coating having the curved surface portions are capable of preventing the stress from concentrating around the corner portions where the stress tends to concentrate. Accordingly, the corner portions of the insulation coating can prevent generation of cracks in the core, which occur initially from peripheries of the corner portions of the insulation coating. This allows the reactor to have appropriate magnetic flux, and improved durability and reliability.

Further, the curvature radius of, the curved surface portions in the curved portions of the insulation coating is set to be 0.2 mm or more, and the minimum thickness of the corner portions of the coating is 0.2 mm or more. Such a numeric arrangement in the curvature radius and the minimum thickness allows the insulation coating to diffuse and ease the stress that is generated around the corner portions of the insulation coating, while the insulation properties is maintained appropriately. The insulation coating should primarily have the appropriate insulation properties.

The curvature radius of each curved surface of the insulation coating can be formed using a mold that is manufactured so as to form the curved surface of the insulation coating having the predetermined curvature radius. Or, it can be formed by an operation in which the corner portion is initially formed to have a desired amount more than the predetermined curvature radius, and then the corner portion is finely cut until it has the predetermined curvature radius.

For example, if the curvature radius of the curved surface portions of the insulation coating is set to be less than 0.2 mm, the insulation coating may not efficiently diffuse and ease the stress generated around the corner portions of the insulation coating.

Further, when the minimum thickness of the curved surface portions is set to be less than 0.2 mm, the insulation coating may not efficiently diffuse and ease the stress generated around the corner portions of the insulation coating. Additionally, the insulation coating may not be provided with appropriate insulation properties that the insulation coating has to have.

The elastic modulus of the core in this aspect of the invention is set to be 5 to 25 GPa at room temperature. Room temperature refers to a temperature ranging from 20° C. to 25° C., which is the temperature where general physical properties are measured. The core having the elastic modulus of 5 to 25 GPa can absorb and ease the stress generated between the coil and the core caused by the repetition of operation and non-operation periods of the coil as well as by the thermal cycles of the coil, while the core is provided with appropriate magnetic properties. This can prevent generation of the cracks in the core.

The elastic modulus of the core can be varied by a selection of an appropriate type of insulation resin to be included in the magnetic powder-containing resin that constitutes the core, or by fixing an amount of magnetic powder to be included in the resin.

For example, the core having the elastic modulus of less than 5 GPa may require less amount of magnetic powder to be included in order to produce the core having desirable elastic modulus, which may result in the core having inappropriate magnetic properties. On the other hand, the core having the elastic modulus of more than 25 GPa may not efficiently absorb and ease the stress that is generated between the coil and the core.

The reactor according to the aspect of the invention prevents the generation of the cracks in the core, and provides appropriate magnetic properties as well as improved durability and reliability.

### BRIEF DESCRIPTION OF THE DRAWING

In the accompanying drawings:

FIG. 1A is a vertical sectional view showing a reactor according to an embodiment of the invention;

FIG. 1B is a sectional view along the line A-A in FIG. 1A;

FIG. 2 is an explanatory drawing showing corner portions and their peripheries of a coil according to the embodiment of the invention; and

FIG. 3 is an explanatory drawing showing corner portions and their peripheries of a coil according to the related art.

### DETAILED DESCRIPTION OF PREFERRED EMBODIMENTS

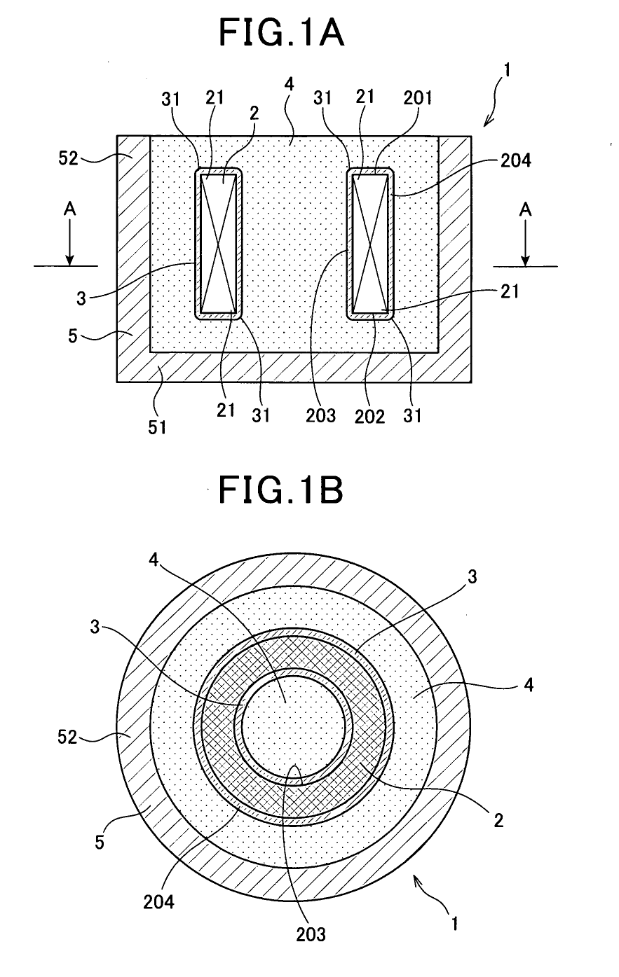

Hereinafter, with reference to FIGS. 1 to 3, a reactor according to an embodiment of the invention will now be described.

The reactor of this embodiment can be used for power converters such as DC-DC converters, inverters and the like. The reactor in the embodiment can also be used for reactors of vehicles mounted on hybrid vehicles or electric vehicles.

The reactor in this embodiment includes a coil covered with an insulation coating, and a core. Metals such as copper, aluminum or silver can be used as a conductive wire that constructs the coil. The reactor includes an insulation coating. Resins such as the silicon resin, urethane resin and epoxy resin can be used to form the insulation coating.

The elastic modulus of the insulation coating should be 0.1 to 200 MPa in a room temperature. The room temperature refers to a temperature ranging from 20° C. to 25° C., which is the temperature where general physical properties are measured.

The insulation coating having the elastic modulus of 0.1 to 200 MPa is able to absorb and ease stress that is generated between the coil and the core caused by the repetition of operation and non-operation periods of the coil as well as by the thermal cycles of the coil. The insulation coating is arranged between the coil and the core. This construction can prevent the generation of the cracks in the core.

The insulation coating having the elastic modulus of less than 0.1 MPa, for example, may not efficiently absorb and ease the stress that is generated between the coil and the core caused by the repetition of operation and non-operation periods of the coil as well as by the thermal cycles of the coil. Further, the insulation coating having the elastic modulus of less than 0.1 MPa may not have appropriate strength, which could cause the insulation coating to deform and have inappropriate insulation properties. On the other hand, the insulation coating having the elastic modulus of more than 200 MPa could not efficiently absorb and ease the stress that is generated between the coil and the core caused by the repetition of operation and non-operation periods of the coil as well as by the thermal cycles of the coil.

The insulation coating includes corner portions each of which has a curved surface portion. The curvature radius of the curved surface portion should be 0.2 to 1.5 mm.

The curved surface portion having a larger curvature radius could result in an insulation coating having a larger thickness, when manufacturing is concerned. That is, generally, the insulation coating is formed so that it has a uniform thickness overall. Therefore, the curved surface portion having the larger curvature radius can cause the insulation coating to have a larger thickness. In such a case (when the curvature radius is more than 1.5 mm, for example) the reactor could fail to have appropriate magnetic properties that the reactor has to have. Accordingly, the curved surface portion should have the curvature radius of less than 1.5 mm in order to efficiently diffuse and ease the stress that is generated around the corner portions of the insulation coating, while maintaining appropriate magnetic properties.

Further, the insulation coating should have a thickness of 0.2 mm or more in order to have appropriate insulation properties that the insulation coating has to have, and to diffuse and ease the stress generated around the corner portions of the insulation coating. Further, the insulation coating should have a thickness of 1.5 mm or less in order to have appropriate magnetic flux with a supply of current to the coil, and appropriate magnetic properties. Accordingly, the insulation coating should have a thickness of 0.2 to 1.5 mm.

Further, for the same reason, the corner portions of the insulation coating should have a minimum thickness of 0.2 to 1.5 mm.

The core included in the reactor is composed of the magnetic powder-containing resin that includes insulation resin. The insulation resin is preferably epoxy resin.

The magnetic powder-containing resin including such an insulation resin is able to absorb and ease the stress that is generated between the coil and the core caused by the repetition of operation and non-operation periods of the coil as well as by the thermal cycles of the coil.

The insulation resin included in the magnetic powder-containing resin can be the phenol resin, urethane resin and others, besides the epoxy resin.

The magnetic powder-containing resin also includes magnetic powder. The magnetic powder can be the ferrite powder, iron powder, silicon base alloy powder and others.

### EXAMPLES

Table 1 shows the results of comparative testing. As shown in this Table 1, multiple types of reactors (samples A1-A5, samples B1-B6, and samples C1-C5) are manufactured and used for comparative testing to determine various properties of the reactors.

As shown in the same Table, the reactors according to the embodiments of the invention (samples A2-A5, B2-B5 and C1-C5) and comparative samples (sample A1 (a conventional art), B1 and B6) were subjected to the comparative testing, and they were compared and evaluated.

First, the fundamental structure of the reactors (samples A1-A5, B1-B6 and C1-C5) will be described.

As shown in FIG. 1, the reactors 1 are used for power converters such as DC-DC converters and inverters. Each of the reactors 1 includes a coil 2 and a core 4. The coil 2 consists of a spirally wound conductive wire, and generates magnetic flux when a current is supplied to the coil 2. The core 4 consists of magnetic powder-containing resin including a mixture of insulation resin (hereinafter “resin for core”) and magnetic powder. The core 4 is arranged around the coil 2.

The reactor 1 includes a storage case 5 that is made of aluminum having excellent radiation properties. The storage case 5 includes a bottom wall portion 51 having a circular plate form and a sidewall portion 52 extending upward from the periphery of the bottom wail portion 51. The storage case 5 stores the coil 2 and the core 4.

As shown in FIG. 1, the coil 2 is made of a rectangular copper wire that is spirally wound, forming a circular cylindrical shape. The coil 2 is embedded in the core 4 that is stored in the storage case 5. The entire surface 20 of the coil 2 is covered with an insulation coating 3 that includes insulation resin (hereinafter “resin for coating”). In this example, the resin for coating included in the insulation coating 3 is the silicon resin.

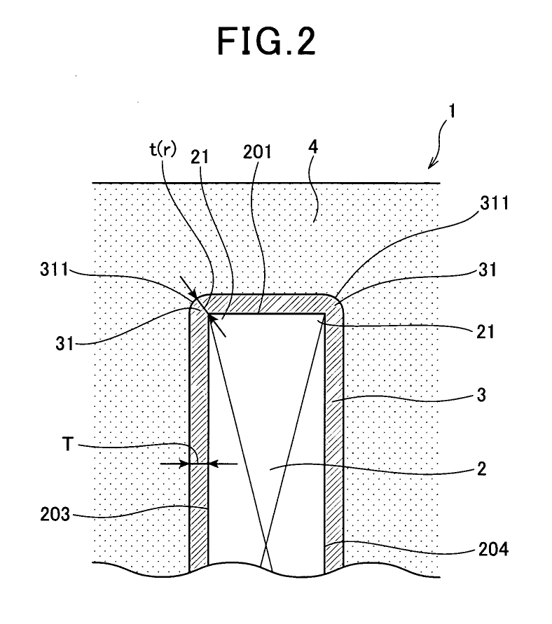

As shown in FIGS. 1 and 2, the insulation coating 3 has corner portions 31 that cover respective corner portions 21 of the coil 2. The corner portions 21 of the coil 2 are formed between two opposing axial end surfaces of the coil 2 (a top end surface 201 and a bottom end surface 202 of the coil 2) and an inner circumference surface 203 of the coil 2, and between the two opposing axial end surfaces of the coil 2 (the top end surface 201 and the bottom end surface 202 of the coil 2) and an outer circumference surface 204 of the coil 2, when viewed in a cross section that is perpendicular to the direction the coil 2 is wound. That is, the corner portions 31 of the insulation coating 3 are disposed over the respective corner portions 21 of the coil 2, thereby covering the corner portions 21 of the coil 2.

As shown in FIG. 2, each of the corner portions 31 of the insulation coating 3 has a curved surface portion 311 that is formed with a circularly curved surface. In this example the curvature radius (r) of the corner portions 311 is set to be the same as the minimum thickness (t) of the corner portions 31 of the insulation coating 3. Further, the minimum thickness (t) of the corner portions 31 of the insulation coating 3 is set to be the same as the thickness (T) of the portions excluding the corner portions 31 of the insulation coating 3. That is, the insulation coating 3 is formed so that it has a generally uniform thickness overall.

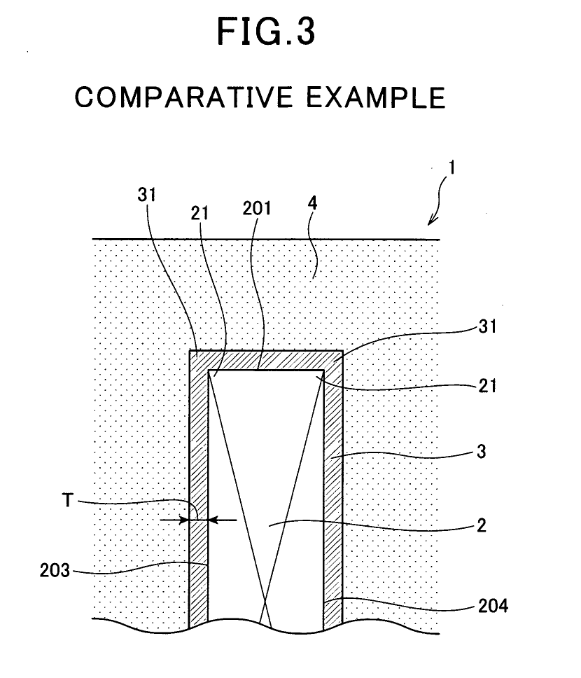

As shown in FIG. 3, in the sample A1, which is a comparative example which is known already, the corner portions 31 of the insulation coating 3 do not have the curved surface portions 311. Thus, the corner portions 31 in the sample A1 have the same shape as the corner portions 21 of the coil 2. The thickness (T) of the insulation coating 3 is set to be 0.6 mm.

As shown in FIG. 1, the core 4 is arranged to fill the inside of the storage case 5, covering the periphery of the coil 2. Accordingly, the core 4 embeds the coil 2 and holds the coil 2. The core 4 consists of the magnetic powder-containing resin that is a mixture of the resin for core and the magnetic powder. In this example, the resin for core included in the insulation coating 4 is the epoxy resin. Iron powder is used as the magnetic powder.

A method for producing the reactors (samples A1-A5, B1-B6 and C1-C5) will be described.

In the method for producing the reactor 1, a cylindrical coil 2 is formed with a single conductive wire having a flat rectangular shape, which is wound in a spiral manner.

Then, the resin for coating is applied over the entire surface 20 of the coil 2. Subsequently, the resin for coating is heated to harden the resin for coating, thereby forming an insulation coating 3 over the entire surface 20 of the coil 2.

Then, the coil 2 covered with the insulation coating 3 is placed inside the storage case 5 using a spacer or the like.

The magnetic powder-containing resin, which has been prepared in advance by mixing the magnetic powder into the resin for core, is filled in the storage case 5. In this stage the magnetic powder-coating resin should be filled so that the resin covers the coil 2 so as to embed the coil 2. Then, the magnetic powder-containing resin is heated to harden the same resin, thereby forming a core 4 that embeds the coil 2 in the storage case 5. Accordingly, the reactor 1 is manufactured.

The shape and various properties of the reactors (samples A1-A5, B1-B6 and C1-C5) will be described.

As shown in Table 1, in this example, the reactors are manufactured so that they have the curved surface portions with different curvature radius (r), the insulation coatings with different elastic modulus, and the cores with different elastic modulus.

As shown in the same Table, the samples A1-A5 are manufactured so that they have the cores having the same elastic modulus, and the insulation coatings having the same elastic modulus, as well as the curved surface portions having the curvature radius (r) of 0.2 to 2.0 mm. The sample A1, however, does not have the curved surface portions at the corner portions of the insulation coating (see FIG. 3), so that the curvature radius (r) thereof indicates 0 (zero) mm.

The samples B1-B6 are manufactured so that they have the curved surface portions having the same curvature radius (r), the insulation coatings having the same elastic modulus, and the cores having an elastic modulus of 4 to 30 GPa.

The samples C1-C5 are manufactured so that they have the curved surface portions having the same curvature radius (r), the cores having the same elastic modulus, and the insulation coatings having an elastic modulus of 0.1 to 300 MPa.

The reactors in this example were manufactured using molds that were able to form the curvature radius (r) of respective insulation coatings in a process of forming the insulation coatings. The elastic modulus of the core is adjusted by fixing an amount of magnetic powder (the iron powder in this example) to be included in the core and the polymerization degree of the resin for core (the epoxy resin in this example) to be included in the core. The sample B1 contains the magnetic powder with a small amount so as to obtain the predetermined elastic modulus.

Further, the elastic modulus of the insulation coating is adjusted by fixing the polymerization degree or the resin component of the resin for coating (the silicon resin in this example).

The comparative testing performed to determine various features of the reactors (samples A1-A5, B1-B6 and C1-C5) will be described.

As shown in Table 1, in this example, each reactor was subjected to the testing and evaluation of the thermal cycle fatigue test, the operation non-operation fatigue test, and the magnetic properties proof test.

The thermal cycle fatigue test was performed in such a manner that the manufactured reactors are placed under an environment of −40° C. for 1.5 hours, and then replaced under an environment of 150° C. for 1.5 hours. This process was calculated as one cycle, and this cycle was performed repeatedly. A number of cycle times was calculated until a time at which a crack was generated in their external appearance (whether a crack was formed in the core) or until the magnetic properties of the reactors was deteriorated (whether the predetermined magnetic properties was maintained the same as before the testing), through a process in which the external appearance of the reactors and the magnetic properties were under inspection.

The operation and non-operation fatigue test was performed in such a manner that the manufactured reactors were placed under the environment of −40° C., where the temperature of the coils were cooled down to −40° C. by termination of a current to the coil, right after the coil had been heated up to 150° C. by the current. These two actions were calculated as one cycle, and this cycle was performed repeatedly. A number of cycle times was calculated until a time at which a crack was generated in the reactors (whether the cracks were formed) or until the magnetic properties of the reactors was deteriorated (whether the predetermined magnetic properties was maintained the same as before the testing), through a process in which the external appearance of the reactors and the magnetic properties were under inspection.

In the magnetic properties proof test, the inductance value was measured. The inductance value is obtained when a current is flown through the coil. This measurement was performed using the multiple current value (0 ampere, 180 ampere, etc.), and evaluated whether the inductance value of each coil was in a predetermined range in each current value. In Table 1, the mark “o” indicates that the inductance value is in the predetermined range, and the mark “Δ” indicates that a plurality of inductance values is in part outside the predetermined range.

TABLE 1

| | | | ELASTIC | | | |
|---|---|---|---|---|---|---|
| | | ELASTIC | MODULUS OF | | OPERATION/ | |
| | CURVATURE | MODULUS OF | INSULATION | THERMAL | NON-OPERATION | MAGNETIC |
| SAMPLES | RADIUS(mm) | CORE (GPa) | COATING(MPa) | CYCLES(TIMES) | (TIMES) | PROPERTIES |
| A1 | 0 | 10 | 1 | 0 (cracked when | Not detectable | ◯ |
| | | | | been formed) | | |
| A2 | 0.2 | 10 | 1 | 100 | 150< | ◯ |
| A3 | 0.6 | 10 | 1 | 300< | 150< | ◯ |
| A4 | 1.5 | 10 | 1 | 300< | 150< | ◯ |
| A5 | 2.0 | 10 | 1 | 300< | 150< | Δ |
| B1 | 0.6 | 4 | 1 | 300< | 150< | Δ |
| B2 | 0.6 | 5 | 1 | 300< | 150< | ◯ |
| B3 | 0.6 | 10 | 1 | 300< | 150< | ◯ |
| B4 | 0.6 | 20 | 1 | 100 | 100 | ◯ |
| B5 | 0.6 | 25 | 1 | 70 | 80 | ◯ |
| B6 | 0.6 | 30 | 1 | 10 | 50 | ◯ |
| C1 | 0.6 | 10 | 0.1 | 100 | 150< | ◯ |
| C2 | 0.6 | 10 | 1 | 300< | 150< | ◯ |
| C3 | 0.6 | 10 | 100 | 300< | 150< | ◯ |
| C4 | 0.6 | 10 | 200 | 300< | 100 | ◯ |
| C5 | 0.6 | 10 | 300 | 300< | 50 | ◯ |

With reference to Table 1, the results of the comparative testing that examined various features of the reactors (samples A1-A5, B1-B6 and C1-C5) will be described.

First, the results of the samples A1-A5 will be described. They have the curved surface portions each having different curvature radius (r). The curved surface portions are formed at the respective corner portions of the insulation coating.

The sample A1, which is a comparative example (a conventional example), formed cracks (fracture) at a time the sample was manufactured prior to the thermal cycle fatigue test, because it was not provided with the curved surface portions at the corner portions of the insulation coating. In addition, the sample A1 soon formed additional cracks during the operation non-operation fatigue test, resulting in the failure of measurement in this testing.

For the samples A2-A5, which are examples of the present invention, exhibit 100 times or more (sometimes more than 300 times) in a number of cycle times in the thermal cycle fatigue test. Further, a number of cycle times in the operation non-operation fatigue test is more than 150 times.

Consequently, it is found that the curved surface portions having the curvature radius (r) of 0.2 mm or more are able to diffuse and ease the stress that is generated by the repetition of operation and non-operation periods of the coil as well as by the thermal cycles of the coil, which thereby prevents the generation of cracks in the core as an advantage of the invention.

Further, the testing shows that the samples A2-A4 were provided with appropriate magnetic properties, but the sample A5 was not. This is because the thickness (T) of the insulation coating of the sample A5 was set to be the same as the curvature radius (r), which eventually caused the thickness (T) of the insulation coating to enlarge (the thickness (T) was set to be the same as the minimum thickness (t) of the corner portion of the insulation coating). The sample A5, with such a construction, failed to have appropriate magnet flux to provide desired magnetic properties.

Accordingly, it is assumed that if the thickness (T) of the insulation coating is set to be such a thickness that does not influence the magnetic properties, an advantage of the invention can be employed, even if the curvature radius (r) is set to be 2.0 mm or more like the sample A5.

However, on a manufacturing basis, the larger the curvature radius (r), the larger the coating thickness (T) will be, which may result in a reactor having inappropriate magnetic properties. Therefore, the curvature radius (r) should be in a range of 0.2 to 1.5 mm.

The samples B1-B6 having the cores with different elastic modulus will be described with reference to Table 1.

The sample B1, a comparative example, shows appropriate results in the thermal cycle fatigue test and the operation non-operation fatigue test, but shows an inappropriate result in the magnetic properties. This may because the core was provided with a smaller amount of magnetic powder in order to adjust its elastic modulus to the predetermined value (less than 5 MPa).

The sample B6, a comparative example, shows satisfactory results in the operation non-operation fatigue test and the magnetic properties. However, the sample B6 shows an unsatisfactory result in the thermal cycle fatigue test that indicates only ten times in a number of cycle times. This is because the core of the sample B6 was provided with high elastic modulus, so that the core failed to efficiently absorb and ease the stress that was generated between the coil and the core caused by the thermal cycles of the core.

On the other hand, the samples B2-B5, examples of the invention, withstand 70 or more (sometimes more than 100 and 300) cycle times in the thermal cycle fatigue. Further, a number of cycle times in the operation, and non-operation fatigue test reaches 80 times or more (sometimes more than 100 or even 150 times). In addition, they have appropriate magnetic properties.

Consequently, it is found that the elastic modulus of the core in a range of 5 to 25 GPa can diffuse and ease the stress that is generated by the repetition of operation and non-operation periods in the coil as well as by the thermal cycles in the coil, which thereby prevents the generation of the cracks in the core as an advantage of the invention.

The samples C1-C6 whose insulation coatings have different elastic modulus will be described with reference to Table 1.

The samples C1-C5, examples of the present invention, exhibit 100 times or more (more than 300 times) in a number of cycle times in the thermal cycle fatigue test. In addition, they have appropriate magnetic properties. However, even the samples C1-C5 show a number of cycle times that is 50 times or more (more than 100 and 150 times) in the operation non-operation fatigue test, the number decreases gradually as the elastic modulus of the insulation coating increases.

Consequently, it is found that the elastic modulus of the insulation coating in a range of 0.1 to 200 MPa can diffuse and ease the stress that is generated by the repetition of operation and non-operation periods in the coil as well as by the thermal cycles in the coil, which thereby prevents the generation of the cracks in the core. This is an advantage of the invention.

What is claimed is:

1. A reactor comprising;
a cylindrical coil that generates magnetic flux with supply of a current, the coil being made of a conductive wire spirally wound;
a core made of magnetic powder-containing resin made of a mixture of insulation resin and magnetic powder, the core being arranged to cover the coil, an entire surface of the coil is covered with the insulation coating, the insulation coating includes corner portions, the corner portions of the insulation coating covers respective corner portions of the coil, the corner portions of the coil are formed between two opposing axial end surfaces of the coil and an inner circumference surface of the coil, and between the two opposing axial end surfaces of the coil and an outer circumference surface of the coil, when viewed in a cross section that is perpendicular to the direction the coil is wound;
each of the corner portions of the insulation coating includes a curved surface portion formed with a circularly curved surface having the curvature radius of 0.2 mm or more; and
the core abutting the insulation coating has an elastic modulus of 5 to 25 GPa at room temperature.

2. The reactor according to claim 1, wherein the elastic modulus of the insulation coating is set to be 0.1 to 200 MPa at room temperature.

3. The reactor according to claim 1, wherein the curved surface portion of the corner portion of the insulation coating has a curvature radius of 0.2 to 1.5 mm.

4. The reactor according to claim 1, wherein the magnetic powder-containing resin includes insulation resin that is epoxy resin.

5. A reactor comprising:
a cylindrical coil, made of a conductive wire spirally wound, which generates magnetic flux in response to supply of a current;
an insulation coating that covers an entire surface of the coil and includes corner portions covering respective corner portions of the coil;
a core made of magnetic powder-containing resin, the magnetic powder-containing resin being made of a mixture of insulation resin and magnetic powder, the core being arranged to surround the coil outside the insulation coating; wherein
the corner portions of the coil being formed between two opposing axial end surfaces of the coil and an inner circumference surface of the coil, and between the two opposing axial end surfaces of the coil and an outer circumference surface of the coil, when viewed in a cross section that is perpendicular to the direction the coil is wound;
each of the corner portions of the insulation coating has a curved surface portion formed with a circularly curved surface having a curvature radius of 0.2 mm or more; and
the core abutting the insulation coating, and having an elastic modulus of 5 to 25 GPa at room temperature.
